(19) United States
(12) Patent Application Publication
(10) Pub. No.: US 2006/0029509 A1
(43) Pub. Date: Feb. 9, 2006

(54) Trochoid pump

(75) Inventors: Masakazu Kurata, Yokohama (JP); Takumi Hisazumi, Kanagawa (JP); Yasuhito Nakakuki, Kanagawa (JP); Mitsuaki Nakada, Kanagawa (JP); Mizuo Otaki, Kanagawa (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 11/189,830

(22) Filed: Jul. 27, 2005

(30) Foreign Application Priority Data
Aug. 9, 2004 (JP) 2004-232048

(51) Int. Cl. F01C 1/02; F01C 1/063; F03C 2/00; F03C 4/00

(52) U.S. Cl. 418/61.3

(57) ABSTRACT

A trochoid pump for supplying hydraulic fluid to a power cylinder in a power steering system. The trochoid pump includes a housing formed therein with an annular operating chamber. Outer rotor having internal teeth and inner rotor having external teeth are rotatably accommodated in the operating chamber in such a manner that the internal and external teeth are engageable with each other. A driving shaft is provided for rotationally driving the inner rotor. A low pressure passage is opened to a clearance between an outer peripheral surface of the outer rotor and an inner peripheral surface of the operating chamber within a discharge region at side of an engaging section at which the volume of the pump chamber is the minimum so as to release a high pressure applied to the outer peripheral surface of the outer rotor, to a low pressure side.

### BACKGROUND OF THE INVENTION

This invention relates to improvements in a trochoid pump adapted, for example, to supply lubricating oil to various sliding sections of an automotive vehicle or to supply hydraulic pressure to a hydraulic power cylinder for assisting a steering effort in a power steering system.

A trochoid pump, for example, used in an automotive vehicle includes an outer rotor having internal teeth which are integrally formed at the inner peripheral side of the outer rotor. An inner rotor has external teeth which are integrally formed at the outer peripheral side of the inner rotor. The external teeth of the inner rotor are engageable with the internal teeth of the outer rotor. A plurality of pump chambers are formed between the internal and external teeth and includes a first group of the pump chambers located at one side of a confining section where the volume of the pump chambers becomes the maximum and a second group of pump chambers located at the other side of the confining section. The first group of the pump chambers are in communication with a suction port region while the second group of the pump chambers are in communication with a discharge port region.

In the pump chambers at a discharge side, a pump discharge pressure is applied in such a direction that the outer rotor separates from the inner rotor. Accordingly, a tip clearance between the tip portions of the internal teeth of the outer rotor and the external teeth of the inner rotor becomes larger at the confining section. This inevitably allows hydraulic fluid in the high pressure pump chambers at the discharge side to leak to the low pressure pump chambers at a suction sdie, thereby lowering a pump efficiency.

In view of the above, in a trochoid pump disclosed in Japanese Patent Provisional Publication No. 11-117876, a high pressure introduction passage is formed to introduce a high pressure hydraulic fluid radially leaked from side clearances (each of which is formed between each of the opposite side surfaces of the outer rotor and each of a facing surfaces of first or second side plate) to the outer peripheral side of the outer rotor at the discharge side. Additionally, a low pressure introduction passage is formed to introduce a suction pressure or low pressure to the outer peripheral side of the outer rotor at the suction side. Under the actions of the high pressure within the high pressure introduction passage and the low pressure within the low pressure introduction passage, the outer rotor is pressed toward the side of the confining section. With this arrangement, the tip clearance between the internal teeth and the external teeth at the side of the confining section is decreased thereby preventing leak of hydraulic fluid from the discharge side pump chambers to the suction side pump chambers.

### SUMMARY OF THE INVENTION

Now, in general, a machining tolerance formed during formation and machining of the outer and inner rotors exists in a trochoid pump and the like. This machining tolerance unavoidably changes a tip clearance between the internal tooth and the outer rotor and the external tooth of the inner rotor. A frictional resistance between the internal and external teeth is unavoidably changed with the above change in the tip clearance. Hence, smooth rotation of the inner and outer rotors are impeded while offering a fear that interference foreign noise is generated between the internal and external teeth owing to unstable engagement between the internal and external teeth. Additionally, the change in tip clearance between the internal and external teeth changes the amount of hydraulic fluid leaking through the tip clearance, thereby causing generation of pulsation of hydraulic pressure.

These technical problems are encountered also in the trochoid pump disclosed in the above Japanese Patent Provisional Publication. Particularly in this trochoid pump, as discussed above, the high pressure introduction passage is formed at the discharge side in addition to formation of the low pressure introduction passage at the suction side, thereby compulsorily pressing the outer rotor to the side of the inner rotor. Consequently, a press-contact force between the tip portions of the internal and external teeth becomes large at the side of the confining section, thus making a frictional resistance excessively large. As a result, a driving load of the trochoid pump unavoidably increases.

It is, therefore, an object of the present invention to provide an improved trochoid pump which can effectively overcome drawbacks encountered in conventional trochoid pumps of the similar nature.

Another object of the present invention is to provide an improved trochoid pump which can ensure a stable pump discharge amount regardless of a machining tolerance of an outer rotor and an inner rotor.

A further object of the present invention is to provide an improved trochoid pump which can obtain stable rotation of an inner rotor and an outer rotor while preventing an interference foreign noise from generating between the internal and external teeth of the outer and inner rotors.

A still further object of the present invention is to provide an improved trochoid pump which can be prevented from changing in tip clearance between the internal and external teeth of outer and inner rotors so that a leak amount of hydraulic fluid decreases and becomes constant thereby suppressing generation of pulsation of hydraulic pressure.

A still further object of the present invention is to provide an improved trochoid pump which is low in press-contact force between the internal and external teeth of outer and inner rotors, thereby preventing a driving load of the trochoid pump from increasing.

An aspect of the present invention resides in a trochoid pump including a housing formed therein with an annular operating chamber. An outer rotor is rotatably accommodated in the operating chamber and has a plurality of internal teeth formed continuous in a peripheral direction at an inner peripheral side of the outer rotor. An inner rotor is rotatably disposed inside the outer rotor and has a plurality of external teeth formed continuous in a peripheral direction of the inner rotor, the external teeth being engageable with the internal teeth of the outer rotor. A driving shaft is provided for rotationally driving the inner rotor. Here, a plurality of pump chambers are formed between the internal teeth of the outer rotor and the external teeth of the inner rotor, the pump chambers including the pump chambers within a suction region where a volume of each pump chamber increases with rotation of the driving shaft, and the pump chambers within a discharge region where a volume of each pump chamber decreases with rotation of the driving shaft. A suction port is opened to the pump chambers within the suction region. A discharge port is opened to the pump chambers within the discharge region. Additionally, a low pressure passage is opened to a clearance between an outer peripheral surface of the outer rotor and an inner peripheral surface of the operating chamber within the discharge region at side of an engaging section at which the volume of the pump chamber is the minimum so as to release a high pressure applied to the outer peripheral surface of the outer rotor, to a low pressure side.

Another aspect of the present invention resides in a trochoid pump including a housing formed therein with an annular operating chamber. An outer rotor is rotatably accommodated in the operating chamber and has a plurality of internal teeth formed continuous in a peripheral direction at an inner peripheral side of the outer rotor. An inner rotor is rotatably disposed inside the outer rotor and has a plurality of external teeth formed continuous in a peripheral direction of the inner rotor, the external teeth engageable with the internal teeth of the outer rotor. A driving shaft is provided for rotationally driving the inner rotor. Here, a plurality of pump chambers are formed between the internal teeth of the outer rotor and the external teeth of the inner rotor, the pump chambers including the pump chambers within a suction region where a volume of each pump chamber increases with rotation of the driving shaft, and the pump chambers within a discharge region where a volume of each pump chamber decreases with rotation of the driving shaft. A suction port is opened to the pump chambers within the suction region. A discharge port is opened to the pump chambers within the discharge region. Additionally, a communication section is formed between the outer peripheral surface of the outer rotor and the inner peripheral surface of the operating chamber in a range of from the discharge region to the suction region at side of an engaging section at which the volume of the pump chamber is the minimum so as to release a high pressure applied to the outer peripheral surface of the outer rotor, to a low pressure side.

A further aspect of the present invention resides in a trochoid pump including a housing formed therein with an annular operating chamber. An outer rotor is rotatably accommodated in the operating chamber and has a plurality of internal teeth formed continuous in a peripheral direction at an inner peripheral side of the outer rotor. An inner rotor is rotatably disposed inside the outer rotor and has a plurality of external teeth formed continuous in a peripheral direction of the inner rotor, the external teeth being engageable with the internal teeth of the outer rotor. A driving shaft is provided for rotationally driving the inner rotor in right or reverse direction. Here, a plurality of pump chambers are formed between the internal teeth of the outer rotor and the external teeth of the inner rotor, the pump chambers including the pump chambers within an engaging section where a volume of each pump chamber becomes the minimum, and the pump chambers within a confining section where a volume of each pump chamber becomes the maximum. A first port is opened between the engaging section and the confining section. A second port is opened between the engaging section and the confining section and separate from the first port. A first low pressure passage is formed at side of the first port and opened to a clearance between an outer peripheral surface of the outer rotor and an inner peripheral surface of the operating chamber so as to release a high pressure applied to the outer peripheral surface of the outer rotor, to a low pressure side. Additionally, a second low pressure passage is formed at side of the second port and opened to a clearance between an outer peripheral surface of the outer rotor and an inner peripheral surface of the operating chamber so as to release a high pressure applied to the outer peripheral surface of the outer rotor, to the low pressure side.

A still further aspect of the present invention resides in a trochoid pump including a housing formed therein with an annular operating chamber. An outer rotor is rotatably accommodated in the operating chamber and has a plurality of internal teeth formed continuous in a peripheral direction at an inner peripheral side of the outer rotor. An inner rotor is rotatably disposed inside the outer rotor and has a plurality of external teeth formed continuous in a peripheral direction of the inner rotor, the external teeth being engageable with the internal teeth of the outer rotor. A driving shaft is provided for rotationally driving the inner rotor. Here, a plurality of pump chambers are formed between the internal teeth of the outer rotor and the external teeth of the inner rotor, the pump chambers including the pump chambers within a suction region where a volume of each pump chamber increases with rotation of the driving shaft, and the pump chambers within a discharge region where a volume of each pump chamber decreases with rotation of the driving shaft. A suction port is opened to the pump chambers within the suction region. A discharge port is opened to the pump chambers within the discharge region. A low pressure passage is opened to a clearance between an outer peripheral surface of the outer rotor and an inner peripheral surface of the operating chamber within the discharge region at side of an engaging section at which the volume of the pump chamber is the minimum so as to release a high pressure applied to the outer peripheral surface of the outer rotor, to a low pressure side. Here, an open end portion of the low pressure passage is intermittently interchangeable between an opening state and a closing state with the outer peripheral surface of the outer rotor.

The other objects and features of this invention will become understood from the following description with reference to the accompanying drawings.

### DETAILED DESCRIPTION OF THE DRAWINGS

In the drawings, like reference numerals designate like elements and parts throughout all figures:

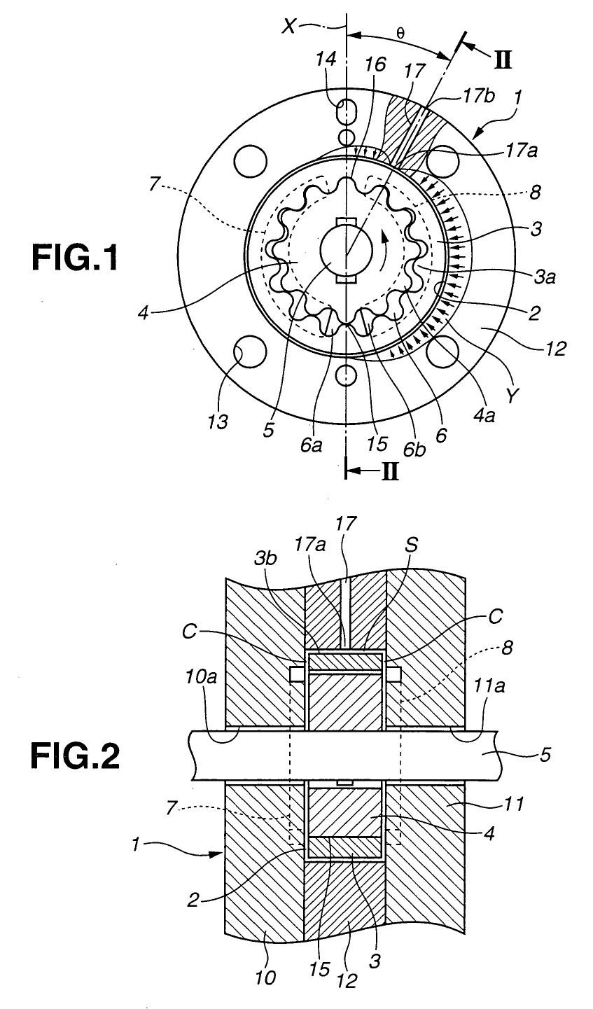

FIG. 1 is a schematic front view of an essential part of a first embodiment of a trochoid pump according to the present invention;

FIG. 2 is a fragmentary sectional view taken in the direction of arrows substantially along the line II-II of FIG. 1;

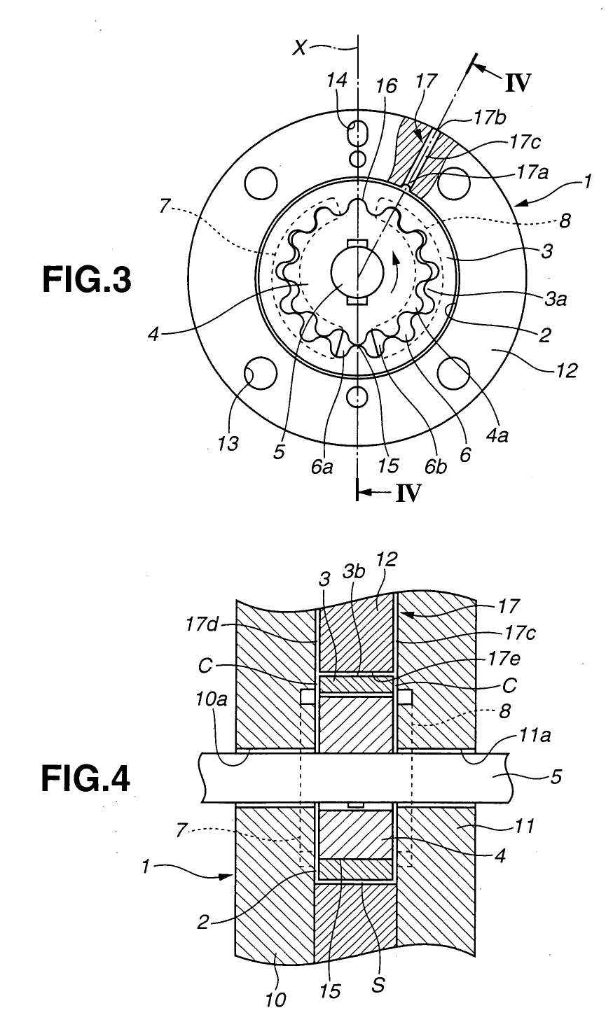

FIG. 3 is a schematic front view of an essential part of a second embodiment of the trochoid pump according to the present invention;

FIG. 4 is a fragmentary sectional view taken in the direction of arrows substantially along the line IV-IV of FIG. 3;

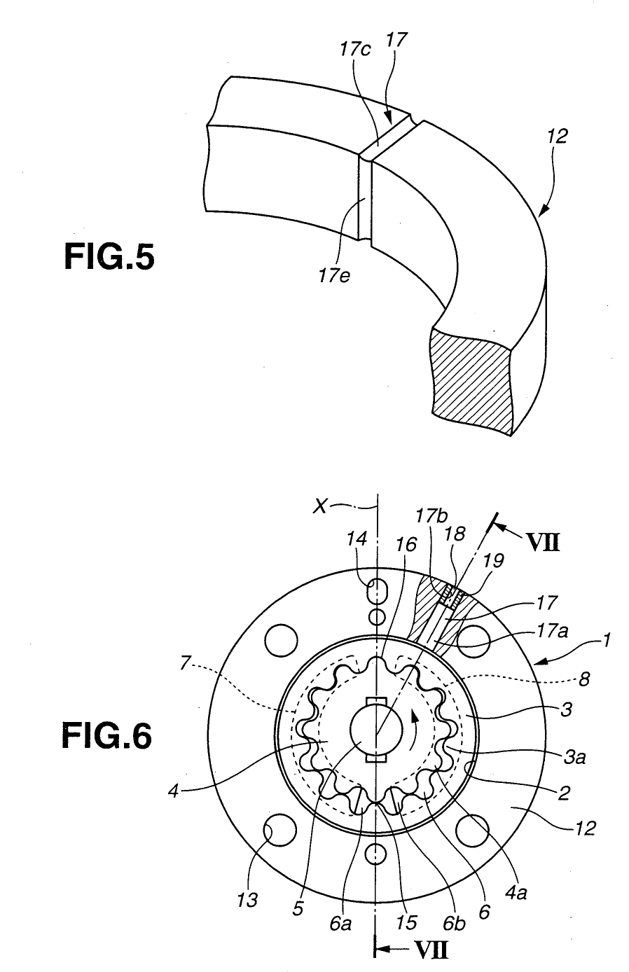

FIG. 5 is a fragmentary perspective view of a cam ring used in the trochoid pump of FIG. 3;

FIG. 6 is a schematic front view of an essential part of a third embodiment of the trochoid pump according to the present invention;

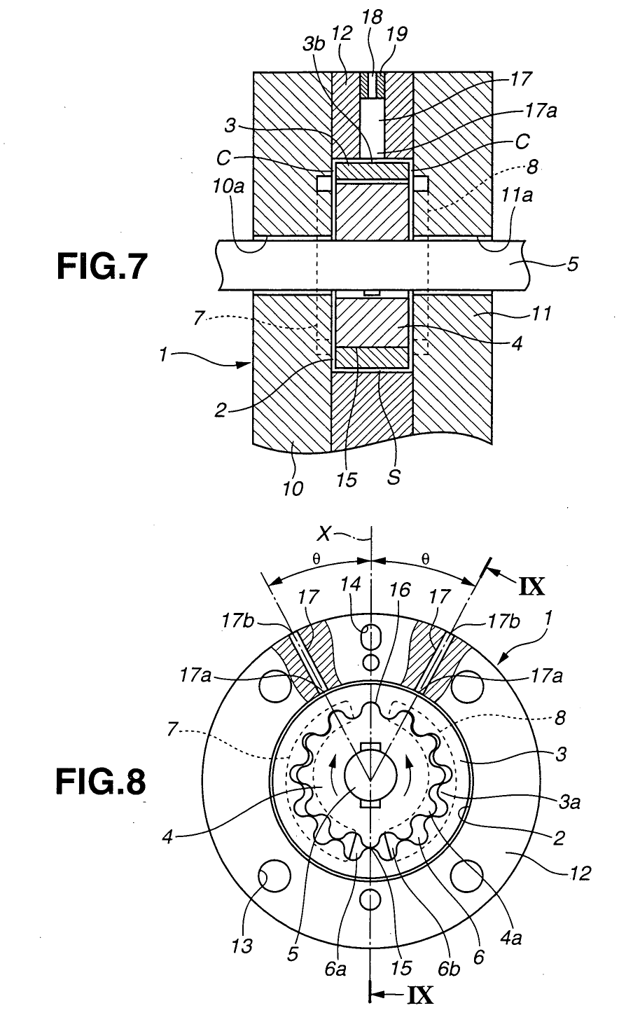

FIG. 7 is a fragmentary sectional view taken in the direction of arrows substantially along the line VII-VII of FIG. 6;

FIG. 8 is a schematic front view of an essential part of a fourth embodiment of the trochoid pump according to the present invention;

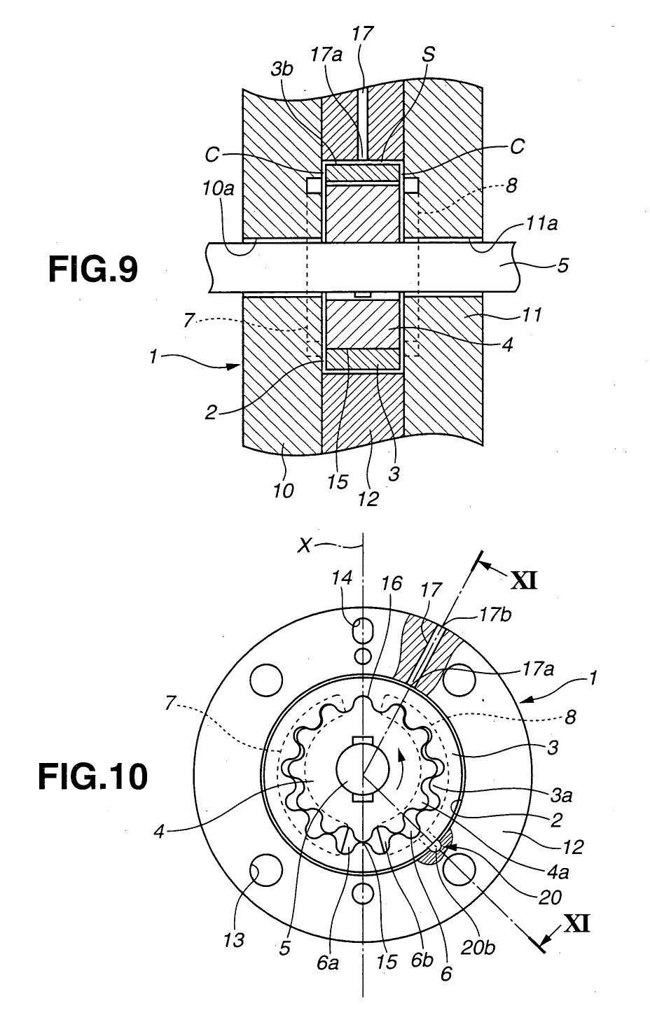

FIG. 9 is a fragmentary sectional view taken in the direction of arrows substantially along the line IX-IX of FIG. 8;

FIG. 10 is a schematic front view of an essential part of a fifth embodiment of the trochoid pump according to the present invention;

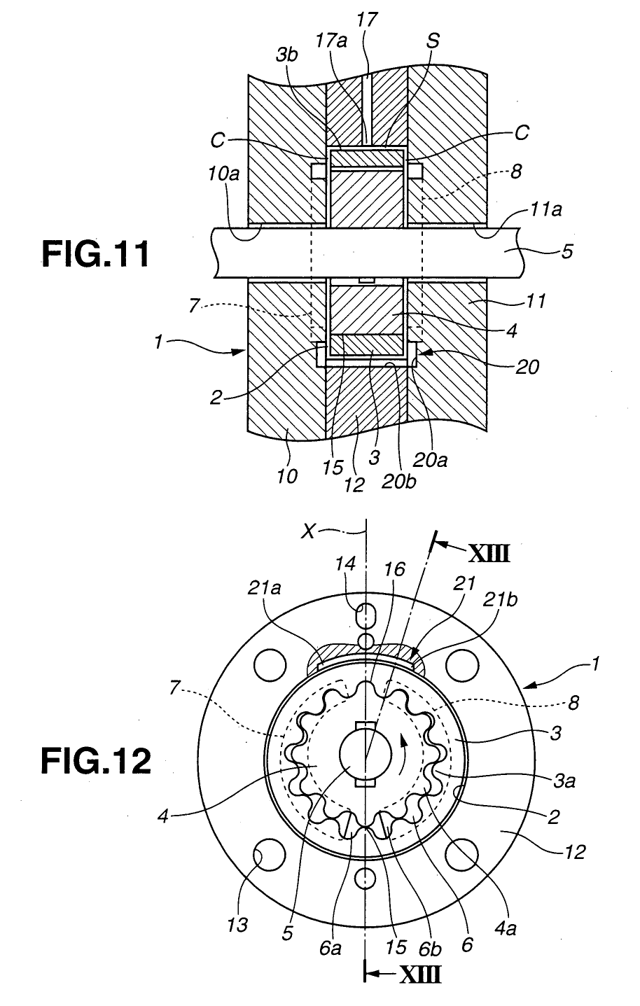

FIG. 11 is a fragmentary sectional view taken in the direction of arrows substantially along the line XI-XI of FIG. 10;

FIG. 12 is a schematic front view of an essential part of a sixth embodiment of the trochoid pump according to the present invention;

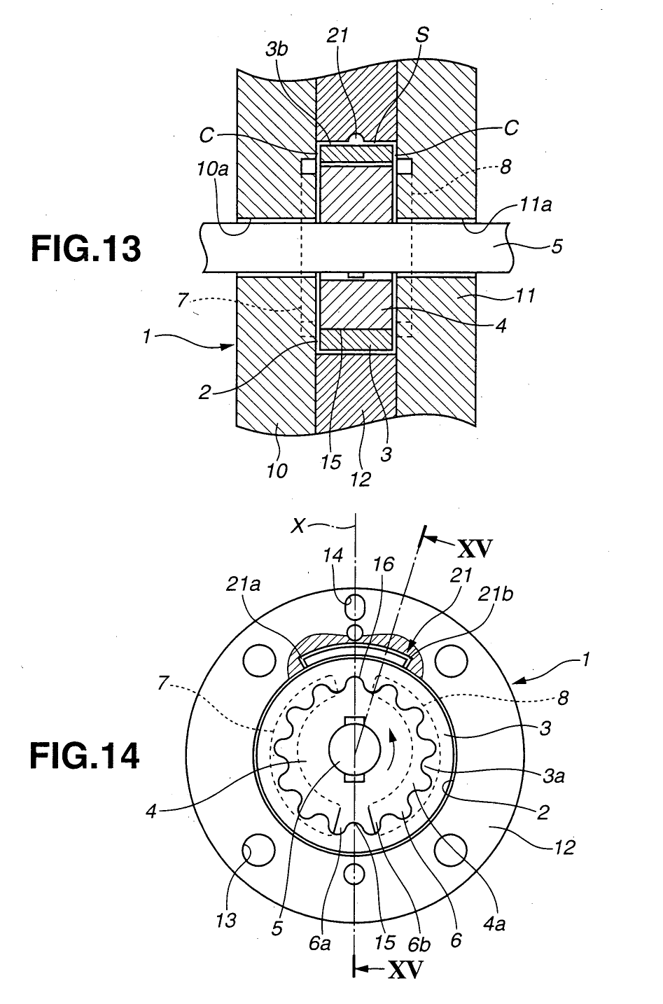

FIG. 13 is a fragmentary sectional view taken in the direction of arrows substantially along the line XIII-XIII of FIG. 12;

FIG. 14 is a schematic front view of an essential part of a seventh embodiment of the trochoid pump according to the present invention; and

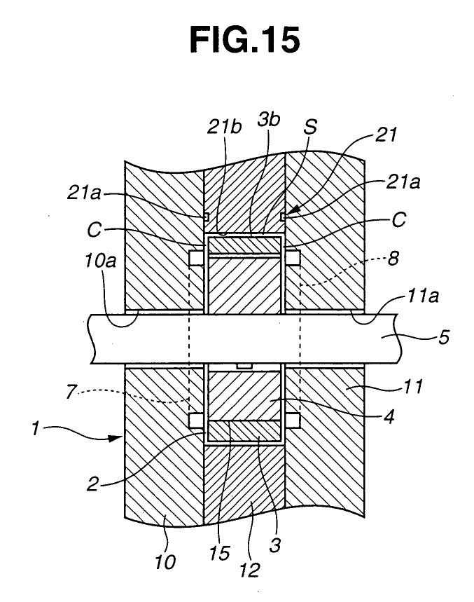

FIG. 15 is a fragmentary sectional view taken in the direction of arrows substantially along the line XV-XV of FIG. 14.

### DETAILED DESCRIPTION OF THE INVENTION

Referring now to FIGS. 1 and 2, a first embodiment of a trochoid pump (inscribing type gear pump) according to the present invention is illustrated. This trochoid pump is to supply a hydraulic pressure selectively to two hydraulic pressure chambers of a hydraulic cylinder for assisting a steering effort, of a power steering system of a vehicle (automotive vehicle).

The trochoid pump includes housing 1 which is formed therein with annular operating chamber 2 which is formed at the inner peripheral side of cam ring 12 which will be discussed after. Outer rotor 3 is rotatably accommodated in operating chamber 2 and has a plurality of internal teeth 3a formed continuous in a peripheral direction at an inner peripheral side of outer rotor 3. Inner rotor 4 is rotatably disposed inside outer rotor 3 and has a plurality of external teeth 4a formed continuous in a peripheral direction of inner rotor 4. External teeth 4a of inner rotor 4 are engageable with internal teeth 3a of outer rotor 3. Driving shaft 5 is provided for rotationally driving inner rotor 4. A plurality of pump chambers 6 are formed between internal teeth 3a of outer rotor 3 and external teeth 4a of inner rotor 4. Pump chambers 6 include pump chambers 6 within a suction region where a volume of each pump chamber 6 increases with rotation of driving shaft 5, and pump chambers 6 within a discharge region where a volume of each pump chamber 6 decreases with rotation of driving shaft 5. Suction port 7 is opened to pump chambers 6 within the suction region. Discharge port 8 is opened to pump chambers 6 within the discharge region.

The whole body of housing 1 is accommodated and disposed within a reservoir tank (not shown). Housing 1 includes first side plate 10 formed in the shape of a thick block and formed of aluminum alloy. Second side plate 11 having a certain thickness is fixed to the rear end side of first side plate 10 by bolts (not shown). Generally cylindrical cam ring 12 is disposed between first side plate 10 and second side plate 11 in a clipped manner. Each of first side plate 10 and second side plate 11 is formed with bolt insertion holes 13 located at four positions of an outer peripheral section thereof, in which the above-mentioned bolts are to be inserted into the bolt insertion holes. Additionally, each of first side plate 10 and second side plate 11 is formed with a pin hole 14 into which a locating pin (not shown) is inserted. First side plate 10 is formed at its generally central portion with shaft hole 10a into which one end section of driving shaft 5 is rotatably inserted, and formed with suction port 7 located at its surface facing operating chamber 2. Second side plate 11 is formed of aluminum alloy and formed at its generally central portion with shaft hole 11a into which the other end of driving shaft 5 is inserted. Additionally, second side plate 11 is formed with a discharge port 8 at its surface facing operating chamber 2.

Additionally, a minute side clearance C is formed between the facing surface (facing to operating chamber 2) of first side plate 10 and second side plate 11 and each of the opposite side surfaces of outer rotor 3.

Cam ring 12 is formed of a sintered metal which is formed thick to have a certain thickness, and formed annular. Cam ring 12 is eccentric relative to inner rotor 4 in such a manner that the location of the axis of the cam ring 12 is separate from the axis of inner rotor 4 by a certain amount. The outer peripheral surface of cam ring 12 is exposed to the inside of the reservoir tank. A minute clearance S is formed between the inner peripheral surface (or inner peripheral surface of operating chamber 2) of cam ring 12 and the outer peripheral surface of outer rotor 3 in order to achieve rotation of outer rotor 3.

As shown in FIG. 1, outer rotor 3 and inner rotor 4 are arranged such that a confining section 15 is formed at a location where the tip portion of internal tooth 3a of outer rotor 3 and the tip portion of external tooth 4a of inner rotor 3 are brought into contact with each other, the location being along a border plane X at a border region between suction port 7 and discharge port 8. Right and left pump chambers 6a, 6b are formed side by side at this confining section 15 and set to take the maximum pump volumes. One pump chamber 6a is in communication with suction port 7, while the other pump chamber 6b is in communication with discharge port 8. Internal tooth 3a and external tooth 4a located on the opposite sides of the axis of inner rotor 4 with respect to confining section 15 and along the above border plane X are in fully engagement with each other thereby forming engaging section 16 at which pump chamber 6 has the minimum (pump) volume. Accordingly, the border plane X is a plane connecting confining section 15 and engaging section 16.

Low pressure passage 17 having a relatively small passage cross-sectional area is formed in cam ring 12 and located near engaging section 16, serving as a communicating means. Low pressure passage 17 extends in a radial direction of cam ring 12.

More specifically, as shown in FIGS. 1 and 2, this low pressure passage 17 is straight and radially formed in cam ring 12, and formed at a widthwise central position or portion in axial direction of cam ring 12. Low pressure passage 17 is formed at a position near discharge port 8 in a peripheral direction of cam ring 12 and located at such an angular position that the axis of low pressure passage 17 forms an angle θ ranging from 20° to 50° relative to the border plane X at the side of engaging section 16. One open end portion 17a of low pressure passage 17 opens to the clearance S between outer peripheral surface 3b of outer rotor 3 and the inner peripheral surface of cam ring 12, while the other open end portion 17b of the same is opened to the inside of the reservoir tank.

Driving shaft 5 is driven to rotate in one direction (indicated by an arrow in FIG. 1) by an electric motor (not shown). Under the rotational driving force of this driving shaft 5, inner rotor 4 and outer rotor 5 are rotated so that hydraulic fluid is sucked through suction port 7 increasing and decreasing the volume of pump chamber 6 while hydraulic fluid is discharged from the confining section 15 taking the maximum pump volume through discharge port 8.

Accordingly, with this trochoid pump, when both rotors 3, 4 are rotated under the rotational driving of the above-mentioned electric motor, hydraulic fluid in each pump chamber 6 leaks through the side clearances C, C in a direction of from the suction region at a low pressure to the discharge region at a high pressure and is introduced into the above-mentioned minute clearance S. Thereafter, hydraulic fluid flows from the clearance S into the low pressure passage 17 through one opened end portion 17a of low pressure passage 17. Then, hydraulic fluid within the low pressure passage 17 is returned to the inside of the reservoir tank.

As a result, outer rotor 3 is pressed in the direction of the axis of driving shaft 5 under the action of high pressure hydraulic fluid leaked into the clearance S through the above-mentioned side clearances C, C within a range of from the suction region to the discharge region. However, hydraulic pressure becomes low at a location near one open end portion 17a of low pressure passage 17. In other words, the whole pressure distribution Y becomes as shown in FIG. 1, in which the pressure becomes relatively high at a location of from the vicinity of confining section 16 to the vicinity of the one open end portion 17a of low pressure passage 17 whereas the pressure lowers at a location around the one open end portion 17a and including engaging section 16.

Consequently, pressure at a location near confining section 15 positioned generally at the opposite side with respect to the one open end portion 17a of low pressure passage 17 is relatively raised thereby generating a differential pressure with which outer rotor 3 is pressed in the direction of low pressure passage 17. By this, the tip portion of internal tooth 3a is brought into press contact with the tip portion of external tooth 4a at confining section 15 thereby decreasing a tip clearance of the internal and external teeth. As a result, hydraulic fluid can be sufficiently prevented from leaking from the pump chambers 6b at a high pressure discharge side to the pump chambers 6a at a low pressure suction side at confining-section 15.

Additionally, with an increase and a decrease in pressure at the side of confining section 15 and at the side of engaging section 16, outer rotor repeatedly radially move between the side of engaging section 16 and the side of confining section 15. As a result, the clearance between outer peripheral surface 3b of outer rotor 3 and the vicinity of one open end portion 17a of low pressure passage 17 increases and decreases thereby repeatedly opening and closing one open end portion 17a so that pressure at a location near low pressure passage 17 is regulated. More specifically, when one open end portion 17a of low pressure passage 17 is opened upon separation of outer peripheral surface 3b of outer rotor 3 from the one open end portion 17a, hydraulic fluid within the clearance S flows into low pressure passage 17 thereby lowering pressure at a location near low pressure passage 17. When one open end portion 17a is closed with outer peripheral surface 3b of outer rotor 3, pressure at a location near one open end portion 17a rises.

Thus, under the balance between the pressure at the location near low pressure passage 17 and the pressure at the side of confining section 15, the axis of outer rotor 3 is regulated so that the press-contact force between internal tooth 3a and external tooth 4a at the side of confining section 15 can be suitably controlled. As a result, a stable pump discharge amount can be ensured regardless of machining tolerance of outer rotor 3 and inner rotor 4. Accordingly, smooth rotation of inner rotor 4 and outer rotor 3 can be achieved while preventing interference foreign noise from generating between internal and external tooth 3a, 4a. Additionally, the (engaging) tip clearance between internal tooth 3a and external tooth 4a at the confining section 15 can be prevented from changing, so that a leak amount of hydraulic fluid decreases and becomes constant thereby suppressing generation of pulsation of pressure.

In this embodiment, low pressure passage 17 is formed at such an angular position that the axis of low pressure passage 17 forms an angle θ ranging from 20° to 50° relative to the border plane X at the side of engaging section 16 upon taking account of the pressure distribution of hydraulic fluid which leaks radially outward through the side clearance at the discharge region and is applied to the outer peripheral surface of outer rotor 3. This makes it possible to suitably accomplish an engaging adjustment between inner rotor 4 and outer rotor 3, i.e., a suitable press-contact action between internal and external teeth 3a, 4a at the confining section 15 and a secure engaging action between internal and external teeth 3a, 4a at engaging section 16.

Further, low pressure passage 17 is formed at the generally central portion of cam ring 12 in widthwise direction thereby suppressing an excessive leak of hydraulic fluid to low pressure passage 17. More specifically, hydraulic fluid passed through the side clearances C, C is introduced to the minute clearance S. Assuming that low pressure passage 17 is formed between first side plate 10 or second side plate 11, there is a fear that hydraulic fluid leaked through the axially opposite end portions of outer rotor 3 excessively discharged outside the trochoid pump through low pressure passage 17. However, according to the present invention, the location of low pressure passage 17 formed is at the generally central portion of cam ring 12 in widthwise direction. This establishes a state where a sealing is made between the axially opposite end portions and low pressure passage 17, thereby suppressing an excessive leak of hydraulic fluid.

Furthermore, other open end portion 17b of low pressure passage 17 is directly opened to the inside of the reservoir tank, and therefore high pressure hydraulic fluid can be easily introduced out to the reservoir tank without forming any special passage.

Moreover, since hydraulic fluid is positively introduced out to the inside of the reservoir tank, contaminants such as metallic powder produced in the trochoid pump can be discharged out of the trochoid pump and to the inside of the reservoir tank.

FIGS. 3 to 5 illustrate a second embodiment of the trochoid pump according to the present invention, similar to the first embodiment with the exception that low pressure passage 17 is formed mainly between each of the opposite side surfaces of cam ring 12 and each of first and second side plates 10, 11.

More specifically, passage grooves 17c, 17d are formed respectively at the opposite side surfaces of cam ring 12. Additionally, oil (fluid) groove 17e is formed at the inner peripheral surface of cam ring 12 to establish communication between the above-mentioned passage grooves 17c, 17d. Accordingly, upon assembly of the trochoid pump, low pressure passage 17 is formed between each of passage grooves 17c, 17d and the facing surface of each of first and second side plates 10, 11, and between oil groove 17e and the outer peripheral surface of the outer rotor, in a state where cam ring 12 is tightly put between first and second side plates 10, 11.

Each of passage grooves 17c, 17d of low pressure passage 17 is formed at such an angular position that the axis of each passage groove 17c, 17d forms an angle θ ranging from 20° to 50° relative to the border plane X at the side of engaging section 16, as same as that in first embodiment.

Accordingly, hydraulic oil leaked through the side clearances C, C to the minute clearance S is collected into the above-mentioned oil groove 17e and then flows into both passage grooves 17c, 17d so as to be smoothly introduced out to the inside of the reservoir tank. Consequently, pressure applied to outer rotor 3 at the side of low pressure passage 17 can be smoothly lowered. Additionally, since passage grooves 17c, 17d are formed at the opposite sides, pressures at the axially opposite sides of outer rotor 3 can be balanced.

Furthermore, when cam ring 12 is formed of a sintered metal under molding, low pressure passage 17 is formed together with forming the cam ring. Therefore, it is unnecessary to separately form low-pressure passage 17, for example, by drilling, thereby facilitating production operation of the trochoid pump.

It will be understood that one of the above-mentioned passage grooves 17c, 17d may be formed without forming the both passage grooves.

FIGS. 6 and 7 illustrate a third embodiment of the trochoid pump according to the present invention, similar to the first embodiment except for an arrangement in which orifice 18 is formed at other open end portion 17b of low pressure passage 17.

More specifically, the location and angular position of low pressure passage 17 formed in cam ring 12 are the same as those of the first embodiment. The cross-sectional area of low pressure passage 17 is set larger than that of the first embodiment. Additionally, orifice forming section (or member defining orifice 18) 19 is press-fitted to the inner surface of other open end portion 17b of low pressure passage 17 so as to be fixed there. Orifice forming section 19 is formed thereinside with an orifice 18 serving as a restriction opening. This orifice 18 has a passage cross-sectional area which is set at a suitable size in connection with pressure to be applied to the clearance S.

It will be understood that it becomes possible to suitably control the amount of hydraulic fluid to be introduced out through low pressure passage 17 under the existence of orifice 18. As a result, pressure around low pressure passage 17 can be prevented from excessively lowering.

FIGS. 8 and 9 illustrate a fourth embodiment of the trochoid pump according to the present invention, similar to the first embodiment with the exception that the trochoid pump can make its rotation in right and reverse directions, serving as a two-rotational direction pump, in which an electric motor (not shown) is rotatable in the right and reverse directions under changing current to be supplied from a controller (not shown) while the driving shaft 5 and inner and outer rotors 4, 3 are also arranged to be rotatable in right and reverse directions. Additionally, the above-mentioned suction port 7 and discharge port 8 are formed to be inverted respectively as a discharge side and a suction side in accordance with the right or reverse rotation of the trochoid pump.

Further, two low pressure passages 17, 17 are straight and radially formed in cam ring 12 and located at such angular positions that each of the axes of low pressure passages 17, 17 forms an angle θ ranging from 20° to 50° relative to the border plane (symmetry plane) X at the side of engaging section 16 so that two low pressure passages 17, 17 are located symmetrical to each other with respect to the border plane X.

Accordingly, also in this embodiment, with the right and reverse rotation of the trochoid pump, hydraulic fluid leaked through each of low pressure passages 17, 17 are introduced out to the inside of the reservoir tank thereby not only offering the same operational effects as those in the first embodiment but also making it possible to conform the trochoid pump to a two-rotational direction pump with a simple structure.

FIGS. 10 and 11 illustrate a fifth embodiment of the trochoid pump according to the present invention, similar to the first embodiment in a basic arrangement including low pressure passage 17. In this embodiment, high pressure introduction section 20 is formed among outer peripheral surface 3b, the inner surface of second side plate 2 and the inner peripheral surface of cam ring 12 in the discharge region around confining section 15 so as to introduce hydraulic fluid from each pump chamber 6 at discharge port 8 into between outer peripheral surface 3b of outer rotor 3 and the inner peripheral surface of cam ring 12.

This high pressure introduction section 20 includes first cutout groove 20a which is formed by cutting out the inner surface of second side plate 11 at a location near discharge port 8 and communicated with the above-mentioned discharge port 8. Second cutout groove 20b is formed by axially cutting out the inner peripheral surface of cam ring 12 at a location corresponding to the radially outside of first cutout groove and communicated with first cutout groove 20a.

Accordingly, hydraulic fluid discharged from pump chambers 6 in the above-mentioned discharge region passes through first cutout groove 20a and is introduced into second cutout groove 20b, and then positively introduced into between the inner peripheral surface of cam ring 12 and outer peripheral surface 3b of outer rotor 3. As a result, lubricating performance can be prevented from lowering at a location between outer peripheral surface 3b of outer rotor 3 and the inner peripheral surface of cam ring 12.

Additionally, a low pressure prevails near one open end portion 17a of low pressure passage 17 while a high pressure prevails near high pressure introduction section 20, on outer peripheral surface 3b of outer rotor 3. Consequently, outer rotor 3 can be more positively biased from the side of confining section 15 to the side of engaging section 16. In addition, hydraulic fluid introduced into second cutout groove 20b flows through the above-mentioned clearance S to the side of low pressure passage 17, and therefore the above-mentioned pressure distribution at outer peripheral surface 3b within a range of from high pressure introduction section 20 to low pressure passage 17 can be uniformalized as compared with the pressure distribution obtained under leaking through side clearances C, C. This suppresses generation of an excessive pressing force against outer rotor 3 in the direction of engaging section 16 in combination with existence of low pressure passage 17. As a result, it is made possible to regulate the contacting force of internal and external teeth 3a, 4a at an suitable pressure in the above-mentioned confining section 15.

FIGS. 12 and 13 illustrate a sixth embodiment of the trochoid pump according to the present invention, similar to the first embodiment in basic arrangement. In this embodiment, a communication groove 21 is formed bridging the suction region and the discharge region at the side of engaging section 16, in place of the low pressure passage in the first embodiment.

More specifically, the above-mentioned communication groove 21 is formed generally semicircular in transverse cross-section at the inner peripheral surface of cam ring 12 and located at the generally central portion of the cam ring in width direction. Additionally, communication groove 21 extends arcuate in the circumferential direction of cam ring 12 in the form of bridging suction port 7 and discharge port 8 so that the center of the communication groove corresponds to the above-mentioned engaging section 16. Communication groove 21 includes one end section 21a and other end section 21b, the border plane X at the side of engaging section 16 residing at the center between the one and other end sections 21a, 21b. One end section 21a extends to a position corresponding to one end side of suction port 7, while other end section 21b extends to a position corresponding to one end side of discharge port 8 which one end side is opposite to the above-mentioned one end side of suction port 7.

Accordingly, with this embodiment, hydraulic fluid flown through the side clearances C, C to the location between outer peripheral surface 3b of outer rotor 3 and inner peripheral surface of cam ring 12 is introduced into one end section 21a of communication groove 21. At this time, one end section 21a of communication groove 21 is located at the side of suction port 7 so as to be in a low pressure state. As a result, a low pressure prevails at the side of outer peripheral surface 3b of outer rotor 3 at the side of engaging section 16. However, with an increase and a decrease in differential pressure between the pressure at the side of confining section 15 and the pressure at the side of engaging section 16, outer rotor 3 repeatedly axially moves between the side of engaging section 16 and the side of confining section 15 thereby repeatedly opening and closing an opened portion of communication groove 21, thus regulating a pressure around communication groove 21. Consequently, the axis of outer rotor can be adjusted under the balance between the pressure around communication groove 21 and the pressure at the side of confining section 15, so that the engaging press-contact force between internal tooth 3a and external tooth 4a at the side of confining section 15 can be suitably regulated. As a result, it is possible to obtain a stable pump discharge amount regardless of the machining tolerance of outer rotor 3 and inner rotor 4.

FIGS. 14 and 15 illustrate a seventh embodiment of the trochoid pump according to the present invention, similar to the sixth embodiment. In this embodiment, communication groove 21 includes two first arcuate grooves 21a, 21a which are formed respectively at opposite side surfaces (at inner peripheral sides) of cam ring 12 on the side of engaging section 16. Second arcuate groove 21b is formed at the inner peripheral surface and connected with two first arcuate grooves 21a, 21a so as to be communicated with two first arcuate grooves 21a, 21a.

Accordingly, with this embodiment, not only the same operational effects as those in the above-mentioned first embodiment can be obtained but also machining for forming communication groove 21 can be facilitated since communication groove 21 is formed at outer surfaces of cam ring 12.

As appreciated from the above, according to the present invention, leak of hydraulic fluid can be prevented from occurring between the tip portions of the internal and external teeth at the confining section between the outer and inner rotors. Additionally, the outer rotor repeatedly radially moves between the side of the engaging section and the side of the confining section with an increase and a decrease in differential pressure between the confining section side and the engaging section side, and therefore the clearance between the outer peripheral surface of the outer rotor and the vicinity of the open end portion of the low pressure passage increases and decreases thereby repeatedly opening and closing the open end portion of the low pressure passage. This can optimally adjust the pressure around the low pressure passage.

As a result, it is made possible to ensure a stable pump discharge amount regardless of a machining tolerance of the outer rotor and the inner rotor. Consequently, a stable rotation of the inner rotor and the outer rotor can be obtained while preventing an interference foreign noise from generating between the internal and external teeth of the outer and inner rotors. Additionally, a change in tip clearance between the internal and external teeth can be prevented so that the leaking amount of hydraulic fluid decreases and becomes constant thereby suppressing generation of pulsation of hydraulic pressure.

Hereinafter, technical ideas other than the above-mentioned, grasped from the above embodiments will be discussed.

(1) In the trochoid pump, the housing includes the cam ring for rotatably supporting the outer rotor at the outer peripheral surface, the first side plate and the rear plate which are disposed respectively at opposite sides of each of the outer rotor, the inner rotor and the cam ring.

Accordingly, the discharge pressure leaked radially from the axially opposite end sides of the outer rotor is introduced to the vicinity of the axially opposite end sides of the cam ring. As a result, there is a fear that hydraulic oil leaked from the axially opposite sides of the outer rotor is excessively released to the outside through the communication means if the low pressure passage is formed between the cam ring and the first side plate or the second side plate. However, by forming the low pressure passage at the central portion of the cam ring in width direction of the cam ring, there is establish a state where a sealing is made between the axially opposite end sides of the outer rotor and the low pressure passage, thereby suppressing excessive leak of hydraulic fluid to the low pressure passage.

(2) The trochoid pump further includes the reservoir tank disposed surrounding the housing and storing hydraulic fluid, wherein the low pressure passage is formed to communicate the inside of the housing and the inside of the reservoir tank.

Accordingly, the outer end side of the low pressure passage is directly opened to the inside of the reservoir tank under an atmospheric pressure condition, at the outer peripheral side of the housing. Therefore, hydraulic fluid at a high pressure can be readily introduced out to the inside of the reservoir tank. Additionally, since hydraulic fluid is positively discharged out to the inside of the reservoir tank, contaminants such as metal powder produced inside the trochoid pump can be discharged out to the inside of the reservoir tank.

(3) In the trochoid pump, the low pressure passage is formed such that its axis inclines toward the discharge region and forms an angle θ ranging from 20° to 50° relative to the engaging section.

Taking account of the pressure distribution of hydraulic fluid leaked outside from the side clearances at the discharge region and supplied to the outer peripheral surface of the outer rotor, the low pressure passage is formed within the above-mentioned angle range, thereby making it possible to suitably accomplish an engagement adjustment between the inner rotor and the outer rotor, i.e., a proper press-contact action between the internal and external teeth at the confining section and a secure engaging action at the engaging section.

(4) The trochoid pump further includes the member defining an orifice, the member being disposed within the low pressure passage.

By providing the orifice defining member, it is possible to suitably control the amount of hydraulic fluid to be introduced out through the low pressure passage, thereby preventing an excessive pressure lowering near the low pressure passage.

(5) In the trochoid pump, the driving shaft, the inner rotor and the outer rotor are arranged to be rotatable in right and reverse directions, and the suction and discharge ports are interchanged with interchanging between the right and reverse direction rotations of the driving shaft etc. Additionally, the first and second low pressure passages are formed symmetrical to each other with respect to a symmetrical plane connecting the confining section and the engaging section.

Accordingly, with a simple structure where a pair of the low pressure passages are provided respectively at the left and right sides of the symmetrical plane, it is possible to apply the invention to a two-rotational direction pump.

(6) The trochoid pump further includes the high pressure introduction section formed for introducing the high pressure from the discharge port into a location between the outer peripheral surface of the outer rotor and the inner peripheral surface of the operating chamber in the discharge region at the side of the engaging section.

Accordingly, hydraulic fluid passed from the discharge port through the clearance between the opposite end portions of the outer rotor and the housing is introduced into the high pressure introduction section between the outer peripheral surface of the outer rotor and the inner peripheral surface of the operating chamber. As a result, a lubricating performance can be prevented from lowering between the outer peripheral surface of the outer rotor and the inner peripheral surface of the operating chamber. Additionally, hydraulic fluid introduced to the high pressure introduction section flows a location between the outer peripheral surface of the outer rotor and the inner peripheral surface of the cam ring, and therefore the pressure distribution at the outer peripheral surface of the outer rotor within the range of from the high pressure introduction section to the low pressure passage can be uniformalized as compared with the pressure distribution due to hydraulic fluid leak through the side clearance. As a result, generation of an excessive pressing force against the outer rotor in the direction of the engaging section can be suppressed in combination with existence of the low pressure passage.

(7) In the trochoid pump, the communication section is formed at the inner peripheral surface of the cam ring and formed bridging sides of the suction and discharge regions which extend to opposite sides of the engaging section.

Accordingly, since the communication section is merely formed at the inner peripheral surface of the cam ring and at a certain angle, a production operation thereof is facilitated, and it is possible to effectively put hydraulic fluid in a low pressure condition within the communication section upon leaking hydraulic fluid in the discharge region.

(8) In the trochoid pump, the cam ring is formed of a sintered metal, and the low pressure passage is formed in the cam ring during formation of the cam ring under sintering.

Accordingly, it is unnecessary to separately form the low pressure passage, thereby facilitating a production operation of the trochoid pump.

It will be understood that the present invention is not limited to the above embodiments, so that, for example, the housing may not be constituted of the first and second side plates so as to be constituted of a housing main body and a rear cover.

The entire contents of Japanese Patent Application No. 2004-232048, filed Aug. 9, 2004, are incorporated herein by reference.

What is clamed is:

1. A trochoid pump comprising:
a housing formed therein with an annular operating chamber;
an outer rotor rotatably accommodated in the operating chamber and having a plurality of internal teeth formed continuous in a peripheral direction at an inner peripheral side of the outer rotor;
an inner rotor rotatably disposed inside the outer rotor and having a plurality of external teeth formed continuous in a peripheral direction of the inner rotor, the external teeth being engageable with the internal teeth of the outer rotor;
a driving shaft for rotationally driving the inner rotor,
wherein a plurality of pump chambers are formed between the internal teeth of the outer rotor and the external teeth of the inner rotor, the pump chambers including the pump chambers within a suction region where a volume of each pump chamber increases with rotation of the driving shaft, and the pump chambers within a discharge region where a volume of each pump chamber decreases with rotation of the driving shaft;
a section defining a suction port opened to the pump chambers within the suction region;
a section defining a discharge port opened to the pump chambers within the discharge region; and
a section defining a low pressure passage opened to a clearance between an outer peripheral surface of the outer rotor and an inner peripheral surface of the operating chamber within the discharge region at side of an engaging section at which the volume of the pump chamber is the minimum so as to release a high pressure applied to the outer peripheral surface of the outer rotor, to a low pressure side.

2. A trochoid pump as claimed in claim 1, wherein the housing includes a cam ring for rotatably supporting the outer rotor at an outer peripheral surface, first and second side plates which are disposed respectively at opposite sides of each of the outer rotor, the inner rotor and the cam ring, wherein the low pressure passage is formed between the cam ring and the first side plate or between the cam ring and the second side plate.

3. A trochoid pump as claimed in claim 1, wherein the housing includes a cam ring for rotatably supporting the outer rotor at an outer peripheral surface, a first side plate and a rear plate which are disposed respectively at opposite sides of each of the outer rotor, the inner rotor and the cam ring.

4. A trochoid pump as claimed in claim 3, wherein the low pressure passage has an open end portion which is located at a generally central portion of the cam ring in a width direction of the cam ring.

5. A trochoid pump as claimed in claim 3, wherein the cam ring is formed of a sintered metal, wherein the low pressure passage is formed in the cam ring during formation of the cam ring under sintering.

6. A trochoid pump as claimed in claim 1, further comprising a reservoir tank disposed surrounding the housing and storing hydraulic fluid, wherein the low pressure passage is formed to communicate the inside of the housing and the inside of the reservoir tank.

7. A trochoid pump as claimed in claim 1, wherein the low pressure passage is formed such that its axis inclines toward the discharge region and forms an angle θ ranging from 20° to 50° relative to the engaging section.

8. A trochoid pump as claimed in claim 1, further comprising a member defining an orifice, the member being disposed within the low pressure passage.

9. A trochoid pump as claimed in claim 1, further comprising a high pressure introduction section for introducing a high pressure from the discharge port into a location between the outer peripheral surface of the outer rotor and the inner peripheral surface of the operating chamber in the discharge region at the side of the engaging section.

10. A trochoid pump comprising:
a housing formed therein with an annular operating chamber;
an outer rotor rotatably accommodated in the operating chamber and having a plurality of internal teeth formed continuous in a peripheral direction at an inner peripheral side of the outer rotor;
an inner rotor rotatably disposed inside the outer rotor and having a plurality of external teeth formed continuous in a peripheral direction of the inner rotor, the external teeth engageable with the internal teeth of the outer rotor;
a driving shaft for rotationally driving the inner rotor;
wherein a plurality of pump chambers are formed between the internal teeth of the outer rotor and the external teeth of the inner rotor, the pump chambers including the pump chambers within a suction region where a volume of each pump chamber increases with rotation of the driving shaft, and the pump chambers within a discharge region where a volume of each pump chamber decreases with rotation of the driving shaft; and
a section defining a suction port opened to the pump chambers within the suction region;
a section defining a discharge port opened to the pump chambers within the discharge region;
a communication section formed between the outer peripheral surface of the outer rotor and the inner peripheral surface of the operating chamber in a range of from the discharge region to the suction region at side of an engaging section at which the volume of the pump chamber is the minimum so as to release a high pressure applied to the outer peripheral surface of the outer rotor, to a low pressure side.

11. A trochoid pump as claimed in claim 10, wherein the communication section is formed at the inner peripheral surface of the cam ring and formed bridging sides of the suction and discharge regions which extend to opposite sides of the engaging section.

12. A trochoid pump as claimed in claim 10, wherein the housing includes a cam ring for rotatably supporting the outer rotor at an outer peripheral surface, a first side plate and a rear plate which are disposed respectively at opposite sides of each of the outer rotor, the inner rotor and the cam ring.

13. A trochoid pump as claimed in claim 12, wherein the communication section is located at a generally central portion of the cam ring in a width direction of the cam ring.

14. A trochoid pump as claimed in claim 12, wherein the cam ring is formed of a sintered metal, wherein the communication section is formed in the cam ring during formation of the cam ring under sintering.

15. A trochoid pump comprising:
a housing formed therein with an annular operating chamber;
an outer rotor rotatably accommodated in the operating chamber and having a plurality of internal teeth formed continuous in a peripheral direction at an inner peripheral side of the outer rotor;
an inner rotor rotatably disposed inside the outer rotor and having a plurality of external teeth formed continuous in a peripheral direction of the inner rotor, the external teeth being engageable with the internal teeth of the outer rotor;
a driving shaft for rotationally driving the inner rotor in right or reverse direction,
wherein a plurality of pump chambers are formed between the internal teeth of the outer rotor and the external teeth of the inner rotor, the pump chambers including the pump chambers within an engaging section where a volume of each pump chamber becomes the minimum, and the pump chambers within a confining section where a volume of each pump chamber becomes the maximum; and
a section defining a first port opened between the engaging section and the confining section;
a section defining a second port opened between the engaging section and the confining section and separate from the first port;
a section defining a first low pressure passage formed at side of the first port and opened to a clearance between an outer peripheral surface of the outer rotor and an inner peripheral surface of the operating chamber so as to release a high pressure applied to the outer peripheral surface of the outer rotor, to a low pressure side; and
a section defining a second low pressure passage formed at side of the second port and opened to a clearance between an outer peripheral surface of the outer rotor and an inner peripheral surface of the operating chamber so as to release a high pressure applied to the outer peripheral surface of the outer rotor, to the low pressure side.

16. A trochoid pump as claimed in claim 15, wherein the first and second low pressure passages are formed symmetrical to each other with respect to a plane connecting the confining section and the engaging section.

17. A trochoid pump as claimed in claim 15, wherein the housing includes a cam ring for rotatably supporting the outer rotor at an outer peripheral surface, a first side plate and a rear plate which are disposed respectively at opposite sides of each of the outer rotor, the inner rotor and the cam ring.

18. A trochoid pump as claimed in claim 15, wherein each of the low pressure passage has an open end portion which is located at a generally central portion of the cam ring in a width direction of the cam ring.

19. A trochoid pump as claimed in claim 17, wherein the cam ring is formed of a sintered metal, wherein the low pressure passage is formed in the cam ring during formation of the cam ring under sintering.

20. A trochoid pump comprising:
a housing formed therein with an annular operating chamber;
an outer rotor rotatably accommodated in the operating chamber and having a plurality of internal teeth formed continuous in a peripheral direction at an inner peripheral side of the outer rotor;
an inner rotor rotatably disposed inside the outer rotor and having a plurality of external teeth formed continuous in a peripheral direction of the inner rotor, the external teeth being engageable with the internal teeth of the outer rotor;
a driving shaft for rotationally driving the inner rotor,
wherein a plurality of pump chambers are formed between the internal teeth of the outer rotor and the external teeth of the inner rotor, the pump chambers including the pump chambers within a suction region where a volume of each pump chamber increases with rotation of the driving shaft, and the pump chambers within a discharge region where a volume of each pump chamber decreases with rotation of the driving shaft;
a section defining a suction port opened to the pump chambers within the suction region;
a section defining a discharge port opened to the pump chambers within the discharge region; and
a section defining a low pressure passage opened to a clearance between an outer peripheral surface of the outer rotor and an inner peripheral surface of the operating chamber within the discharge region at side of an engaging section at which the volume of the pump chamber is the minimum so as to release a high pressure applied to the outer peripheral surface of the outer rotor, to a low pressure side,
wherein an open end portion of the low pressure passage is intermittently interchangeable between an opening state and a closing state with the outer peripheral surface of the outer rotor.
